(19) United States
(12) Patent Application Publication
(10) Pub. No.: US 2008/0080519 A1
(43) Pub. Date: Apr. 3, 2008

(54) Protocol conversion apparatus and method between IPv4 terminal and IPv6 terminal or between application programs using mapping table, and method of generating mapping table of protocol conversion apparatus

(76) Inventors: Min Ho Park, Daejeon (KR); Eui Hyun Paik, Daejeon (KR); Kwang Roh Park, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/642,298

(22) Filed: Dec. 20, 2006

(30) Foreign Application Priority Data
Sep. 29, 2006 (KR) 2006-0095851

(51) Int. Cl. H04L 12/56; H04J 3/16

(52) U.S. Cl. 370/395.54; 370/466

(57) ABSTRACT

Provided is a protocol conversion apparatus and method supporting communication between terminals through a protocol conversion when IPv4/IPv6 terminals coexist or a terminal supports an IPv4/IPv6 dual stack in one physical network but an application service supports a specific protocol. A conventional SIIT protocol conversion technique can be used by receiving a communication request through an IPv4 and IPv6 dual stack for a communication request of an IPv4 terminal or an IPv6 terminal, and supporting a protocol conversion between the IPv4/IPv6 terminal through a mapping table mapping respective actual IP address and virtual IP address of the IPv4 and IPv6, and performing communication between the IPv4/IPv6 terminals. Therefore, it is possible to transparently communicate to each other in an IP protocol version. Moreover, a terminal communicates with another terminal in an external network through a conventional protocol or a protocol conversion technique without modification.

### BACKGROUND OF THE INVENTION

1. Field of the Invention

The present invention relates to a protocol supporting system and method between IPv4 and IPv6, and more particularly, to a protocol function sharing apparatus and method between an IPv4 terminal and an IPv6 terminal or between application programs in the same one physical network. That is, the present invention relates to a protocol conversion apparatus and method supporting communication between terminals through a protocol conversion when IPv4/IPv6 terminals coexist or a terminal supports an IPv4/IPv6 dual stack in one physical network but an application service supports a specific protocol.

2. Description of the Related Art

The most commonly used network protocol in the internet is an internet protocol version 4 (IPv4). The IPv4 protocol plays a very important factor to connect numerous networks and users in a large one network, i.e., the internet, in a short time. However, the IPv4 protocol has disadvantages such as limitation in the number of IP addresses, packet routing inefficiency, and mobility and security difficulties.

To resolve these disadvantages, a new internet protocol version 6 (IPv6) has been being developed recently. The IPv6 is a new IP address system for enhancing the IPv4 that is a currently used IP address system. The IPv6 is an official standard of an internet engineering task force (IETF), and also is called an IP next generation (IPng) in a meaning of a next generation internet communication regulation.

The IPv4 has 4.2 billion addresses in a 32 bit address system, and allocates addresses by classless inter-domain routing (CIDR). On the other hand, unlike the IPv4, the IPv6 in a 128 bit address system has a number of addresses approaching approximately 30 times that of the IPv4, and also hierarchically allocates addresses based on CIDR. The type of address includes unicast, multicast, and anycast.

Accordingly, networks based on the IPv6 have come out recently. A conventional network will be gradually replaced with the IPv6. However, it is difficult in a short time to collectively replace hosts and routers based on the widely spread IPv4 with the IPv6. Thus, IPv4/IPv6 will coexist for a while.

Accordingly, since users having IPv4-based internet environment and users having IPv6-based internet environment need to connect to the internet, it is required to convert respectively different protocols.

The IETF standardizes many protocol conversion techniques. There are well-known techniques such as network address and protocol translation (NAPT), and dual stack transition mechanism (DSTM) among the protocol conversion techniques. The DSTM is a widely used technology when the IPv6 are commonly used. The NAPT is widely used at an early stage of when the IPv4 is mostly used during conversion steps of the IPv4/IPv6.

In a more specific example, “a protocol function sharing method and apparatus under an IPv4-IPv6 coexisting environment” in a Korean Published Patent (application number: 10-2003-005923) has problems in that it is only possible to perform a protocol conversion when a network in each IPv4/IPv6 is divided and connected to respectively different interfaces of a protocol conversion apparatus in order to form respectively separate networks, and also it is impossible to perform a protocol conversion between each IPv4/IPv6 in one physical network.

As described above, conventional protocol conversion techniques in FIG. 1 are possible only when an IPv4/IPv6 network is physically divided into respectively different networks according to an interface of a protocol conversion apparatus.

### SUMMARY OF THE INVENTION

Accordingly, the present invention is directed to a protocol function sharing apparatus and method between an IPv4 terminal and an IPv6 terminal or between application programs in the same one physical network, which substantially obviates one or more problems due to limitations and disadvantages of the related art.

It is an object of the present invention to provide an apparatus and method capable of performing a protocol conversion between IPv4/IPv6 terminals or between application programs in one identical physical subnetwork, which is not a protocol conversion method between physically separated IPv4/IPv6 networks.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method of generating a mapping table of a protocol conversion apparatus, the method including mapping actual IP addresses of IPv4/IPv6 and virtual IP addresses corresponding to the actual IP addresses to support a protocol conversion between IPv4/IPv6 terminals or application programs in one physical network environment mixed with the IPv4/IPv6 terminals or the application programs. The mapping includes: allocating an ARP table and a neighbor table to the IPv4 terminal and the IPv6 terminal, respectively; mapping a virtual IPv6 address into an actual IP address of an IPv4 terminal existing in the ARP table; and mapping a virtual IPv4 address into an actual IP address of an IPv6 terminal existing in the neighbor table.

The IPv4 terminal utilizes an actual IP address in an IPv4 format address and a virtual IP address in an IPv6 format address. The IPv6 terminal utilizes an actual IP address in an IPv6 format address and a virtual IP address in an IPv4 format address.

In another aspect of the present invention, there is provided a protocol conversion apparatus supporting a protocol conversion between IPv4/IPv6 terminals or application programs by using a mapping table, the protocol conversion apparatus transmitting and receiving a communication request of the IPv4 terminal or the IPv6 terminal by using an IPv4/IPv6 dual stack, and supporting a protocol conversion between the IPv4/IPv6 terminals or the application programs in one physical network environment mixed with IPv4/IPv6 by using the mapping table mapping an actual IP address and a virtual IP address of the IPv4/IPv6 terminals, respectively.

The protocol conversion apparatus further includes respective ALGs modify an IP address information in the payload as a value of an actual IP address corresponding to a virtual IP address in the mapping table when the virtual IP address in the mapping table corresponds to a target IP address in the payload, and then transmit the modified IP address information into terminals in cases of IP addresses in payloads such as a DNS, FTP, and a SIP.

In a further another aspect of the present invention, a method of supporting a protocol conversion between IPv4/IPv6 terminals by a mapping table, the method including: receiving and responding for a message for a communication request of the IPv4/IPv6 terminals by using an IPv4/IPv6 dual stack in one physical network environment mixed with IPv4/IPv6; and supporting the protocol conversion between the IPv4/IPv6 terminals by using the mapping table mapping an actual IP address and a virtual IP address of the IPv4 and IPv6, respectively, to perform communication between the IPv4/IPv6 terminals.

The method further includes, in cases of IP addresses in a payload including one of a DNS, a FTP, and a SIP of a terminal that the IPv4 or IPv6 terminal wants to communicate, modifying an IP address information in the payload as a value of an virtual IP address corresponding to the actual IP address through an ALG according to respective applications when an IP address in the payload corresponds to an actual IP address in the mapping table.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 illustrates a network topology for performing a conventional protocol conversion;

FIG. 2 illustrates a network topology applied with a protocol conversion apparatus between IPv4/IPv6 terminals or between application programs using a mapping table according to an embodiment of the present invention;

FIG. 3 illustrates each IPv4/IPv6 terminal connected in the same physical network when being connected to a protocol conversion apparatus having a dual stack, an address mapping table that the protocol conversion apparatus manages, and one interface;

FIG. 4 illustrates a flowchart of a communication procedure between an IPv4 terminal and an IPv6 terminal when the IPv4 terminal connected to one interface of a protocol conversion apparatus initiates communication;

FIG. 5 illustrates a flowchart of a communication procedure between an IPv4 terminal and an IPv6 terminal when the IPv6 terminal connected to one interface of a protocol conversion apparatus commences communication; and

FIG. 6 illustrates a flowchart of a procedure of fetching a virtual address of a corresponding terminal with a domain name of an IPv4 terminal in the same network by an IPv6 connected to one interface of a protocol conversion apparatus.

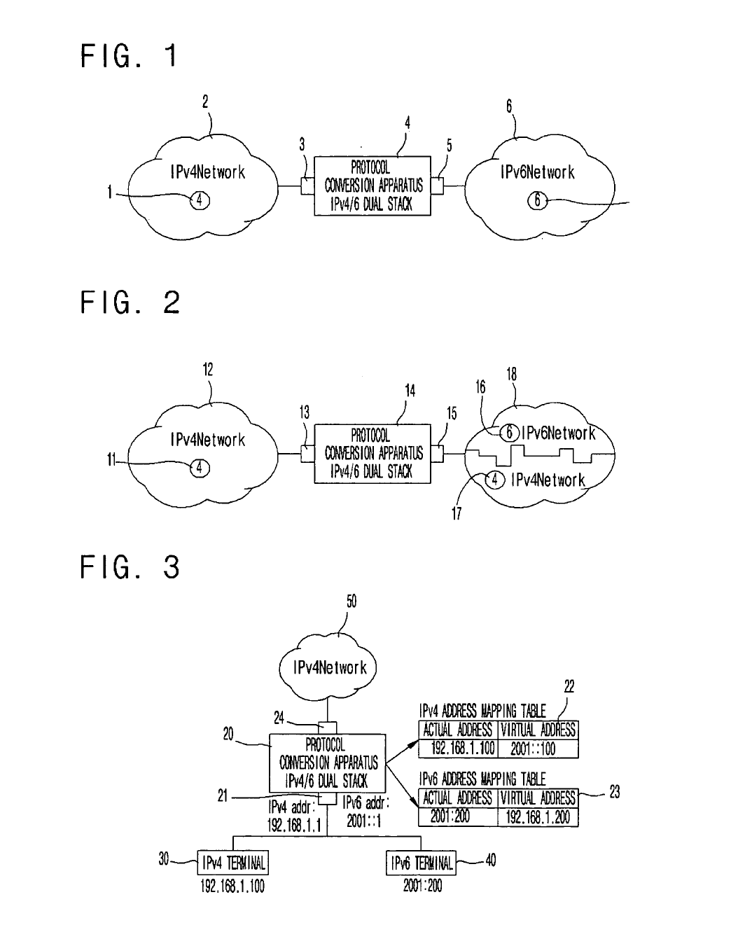

### DETAILED DESCRIPTION OF THE INVENTION

A protocol conversion apparatus between IPv4/IPv6 terminals or between application programs using a mapping table will now be described with reference to the accompanying drawings.

FIG. 2 illustrates a one embodiment of a network topology in that IPv4/IPv6 networks are not separated according to an interface of a protocol conversion apparatus around the protocol conversion apparatus 14. As illustrated in FIG. 2, IPv4/IPv6 network 16 and 17 are not separated from but mixed in the network connected to one interface 15 of the protocol conversion apparatus 14.

Accordingly, a protocol conversion apparatus 14 having an IPv4/IPv6 dual stack maintains a mapping table mapping an actual IP address and a virtual IP address for each IPv4/IPv6 terminal in a network environment of FIG. 2, thereby making it possible to communicate between terminals and between application programs, which utilize IPv4/IPv6 protocols.

Here, an IP address is an IPv4 format address in a case of an IPv4 terminal, and an IPv6 format address in a case of an IPv6 terminal. Contrarily, a virtual IP address is an IPv6 address format in the IPv4 terminal, and an IPv4 address format in the IPv6 terminal. The virtual address is not an address that is actually allocated to a terminal, but is an address that is managed by a protocol conversion apparatus.

FIG. 3 illustrates a conceptual diagram of a network mixed with a protocol conversion apparatus 20 having an IPv4/IPv6 dual stack, mapping tables 22 and 23 that the protocol conversion apparatus 20 manages, an IPv4 network connected to the protocol conversion apparatus 20 and the IPv4/IPv6 dual stack, and IPv4/IPv6 terminals connected to one interface of the protocol conversion apparatus 20.

When examining fundamental components, as illustrated in FIG. 3, the IPv4 terminal 30 and the IPv6 terminal 40 are connected to one interface of the protocol conversion apparatus 20.

The IPv4/IPv6 terminals 30 and 40 transparently operate with respect to a protocol version of terminals communicating with the IPv4/IPv6 terminals 30 and 40. That is, when an IPv4 terminal 30 tries to communicate with an IPv6 terminal 40, an address resolution protocol (ARP) request message about a virtual IP address of a corresponding IPv6 terminal 40 is broadcasted to all terminals in a subnetwork by an ARP procedure.

The ARP request message is broadcasted only in an IPv4 network. Then, an IPv4 stack of a protocol conversion apparatus 20 having a dual stack receives the ARP request message. Since an IP address requested in the received ARP request message is a virtual IP address in a mapping table that the protocol conversion apparatus itself manages, the protocol conversion apparatus transmits a reply message with a MAC address of the protocol conversion apparatus itself in a response to the ARP request message.

An IPv4 terminal inputs a virtual IP address into a target IP address of a packet for transmission, and a MAC address of the protocol conversion apparatus into a target MAC address for transmission. Then, the protocol conversion apparatus 20 receives the transmitted packet. Since the target IP address in the received packet corresponds to a virtual IP address information in a mapping table that the protocol conversion apparatus itself manages, the protocol conversion apparatus 20 converts the received packet into an IPv6 packet by applying a conventional simple IP and ICMP transition (SIIT) conversion technique, and then transmits the corresponding packet to an actual IPv6 terminal.

The IPv6 terminal 40 transmits a packet into the IPv4 terminal 30 by using the same operational method except that a neighbor discovery protocol defined in the IPv6 is utilized instead of an ARP protocol.

Additionally, when an IP address is in a payload such as a domain name service (DNS), a file transfer protocol (FTP), or a session initiative protocol (SIP), application layer gateway functions are separated with respect to each case to determine whether the IP address in the payload corresponds to an actual IP address in the mapping table or not. When the IP address corresponds to the actual IP address, the IP address information in the payload is modified as a value of a virtual IP address of a corresponding entry in the mapping table and then transmitted into a target terminal.

Specifically, as illustrated in FIG. 3, an upstream interface 24 of the protocol conversion apparatus 20 is connected to an IPv4 network, and a downstream interface 21 is connected to a network mixed with the IPv4/IPv6. The protocol conversion apparatus 20 manages mapping tables 22 and 23 mapping actual IP addresses and virtual IP addresses by each protocol.

In the IPv4 terminal 30, an actual IP address is an IPv4 format address (e.g., 10.1.1.1), and a virtual IP address is an IPv6 format address (e.g., 2001:100:2e:1). Contrarily, in the IPv6 terminal 40, an actual IP address is an IPv6 format address (e.g., 2001:100:2e:1), and a virtual IP address is an IPv4 format address (e.g., 10.1.1.1).

In a method of generating the mapping tables 22 and 23, there is an ARP table for the IPv4 terminal 30, and a neighbor table for IPv6 terminal 40. Virtual IPv6 addresses are mapped into the IPv4 terminals 30 in the ARP table, respectively, and virtual IPv4 addresses are mapped into the IPv6 terminals 40, respectively to generate the mapping tables 22 and 23.

When the IPv4 terminal 30 connected to the downstream interface 21 of the protocol conversion apparatus 20 communicates with the IPv4 terminal 30 in the IPv4 network 50 connected to the upstream interface 24, the protocol conversion apparatus 20 supports IPv4/IPv6 dual stack. Therefore, a conventional IPv4 protocol method can be used without modification.

Moreover, when the IPv6 terminal 40 connected to a downstream interface 21 communicates with the IPv4 terminal in the IPv4 network 50 connected to the upstream interface 24, a conventional network address translation-protocol translation (NAPT) technique or a dual stack transition mechanism is utilized.

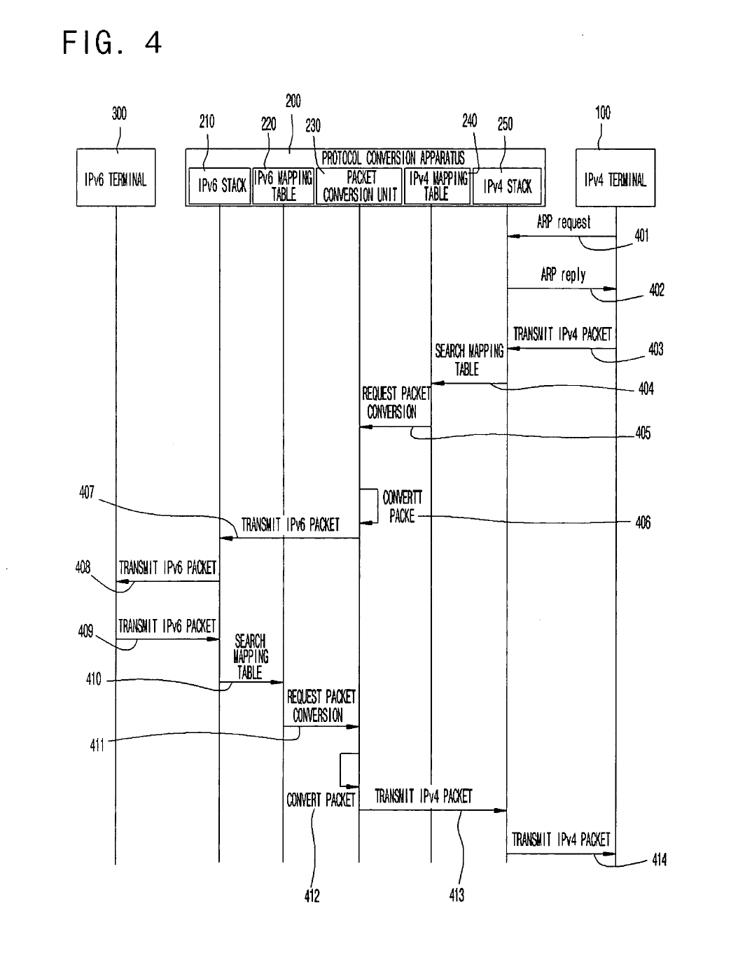

Then, a method of performing a protocol conversion between IPv4/IPv6 terminals and between application programs will be described with reference to FIGS. 4 through 6.

FIG. 4 illustrates a flowchart of a procedure of when the IPv4 terminal 100 connected to one interface of a protocol conversion apparatus 200 communicates with the IPv6 terminal 300 connected to the same interface.

When the IPv4 terminal 100 connected to one interface of a protocol conversion apparatus 200 communicates with the IPv6 terminal 300 connected to the same interface, an ARP request message for a virtual IP address in a corresponding IPv6 terminal 300 is broadcasted in a network connected to the same network in operation S401.

All the IPv4 terminals in a subnetwork receive a corresponding ARP request messages, and also the IPv4 stack 250 of the protocol conversion apparatus 200 receives a corresponding message.

The protocol conversion apparatus 200 recognizes that the corresponding IP address of the ARP request message is a virtual IP address of the mapping table 220 that the protocol conversion apparatus 200 itself manages, and then transmits a MAC address of the protocol conversion apparatus 200 and also an ARP reply message in response to the ARP request message in operation S402.

Since the IPv4 terminal 100 has an IP address and a MAC address of a terminal that the IPv4 terminal 100 wants to communicate, it makes and transmits a frame in operation S403. The target MAC address of the transmitted frame is a MAC address of the protocol conversion apparatus 200 obtained by the ARP request message, and the target IP address is set as a virtual IP address in the corresponding IPv6 terminal 300.

The IPv4 stack 250 of the protocol conversion apparatus 200 receives the corresponding frame. The protocol conversion apparatus 200 receiving the corresponding frame in operation S403 searches the IPv6 mapping table 220 to confirm that the corresponding virtual IP address corresponds to an IP address of the mapping table 220 that the protocol conversion apparatus 200 manages in operation S404, and then transmits the corresponding virtual IP address into a packet conversion unit 230 to convert into an IPv6 packet by applying a SIIT algorithm based on mapping table information in operation S406. Then, a target IPv6 terminal 300 receives a packet by transmitting the IPv6 packet into an IPv6 stack 210 of the protocol conversion apparatus 200 in operation S408. Here, the packet conversion unit 230 follows the SIIT-based a conversion method.

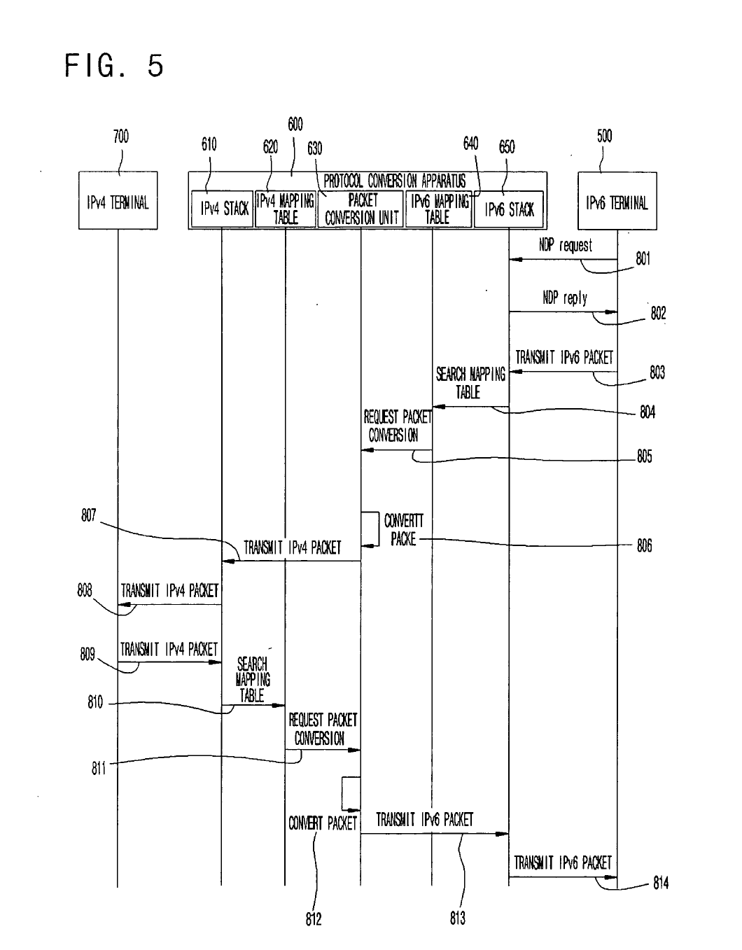

FIG. 5 illustrates a flowchart of a procedure of when the IPv6 terminal 500 connected to one interface of a protocol conversion apparatus 600 communicates with the IPv4 terminal 700 connected to the same interface.

When the IPv6 terminal 500 communicates with the IPv4 terminal 700 in the same subnetwork, a neighbor discovery protocol (NDP) request message for a virtual IP address given for the corresponding IPv4 terminal 700 is multi-casted for IPv6 terminals in operation S801.

All the IPv6 terminals in a subnetwork receive a corresponding NDP request messages, and also the IPv6 stack 650 of the protocol conversion apparatus 200 receives a corresponding NDP request message. The protocol conversion apparatus 600 transmits a MAC address of the protocol conversion apparatus 600 and also an NDP reply message in operation S802 when the IP address of the NDP request message corresponds to a virtual IP address information of the mapping table 620 that the protocol conversion apparatus 600 itself manages.

The IPv6 terminal 500 generates a frame of an IP address and a MAC address of the terminal for communication and then transmits the frame in operation S803. The target MAC address of the transmitted frame is a MAC address of the protocol conversion apparatus 600 obtained by an NDP, and a target IP address is set as a virtual IP address given to the corresponding IPv4 terminal 700.

The protocol conversion apparatus 600 receiving the corresponding frame in operation S803 searches the IPv4 mapping table 620 to confirm that the corresponding virtual IP address corresponds to an IP address of the mapping table 620 that the protocol conversion apparatus 600 manages in operation S804, and then transmits the corresponding virtual IP address into a packet conversion unit 630 to convert into an IPv4 packet in operation S806. Then, a final target IPv4 terminal 700 receives a packet by transmitting the IPv4 packet into the IPv4 stack 610 of the protocol conversion apparatus 600 in operation S808. Here, the packet conversion unit 630 follows the SIIT-based a conversion method.

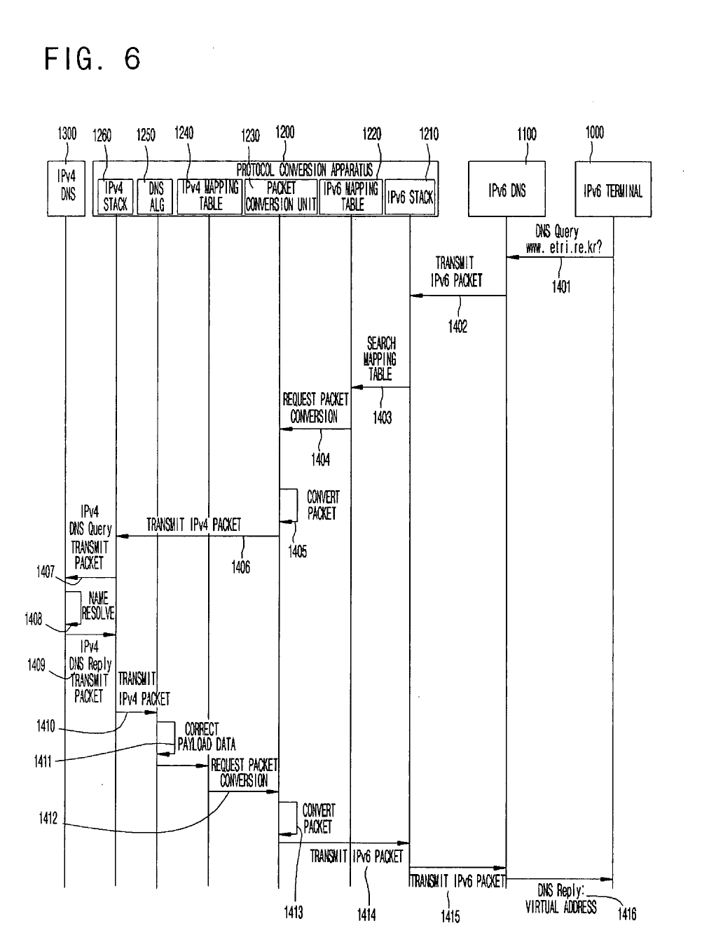

FIG. 6 illustrates a flowchart of procedure of when an IPv6 terminal 1000 connected to one interface of a protocol conversion apparatus 1200 fetches an IPv6 format virtual address of a corresponding IPv4 terminal 1300 with a DNS address of an IPv4 1300 in the same network.

As illustrated in FIG. 6, when an IP address is in a payload such as a DNS, a FTP, or a SIP, application layer gateway functions are separated with respect to each case to determine whether the LP address in the payload corresponds to an actual IP address in the mapping table or not. When the IP address corresponds to the actual IP address, the IP address information in the payload is modified as a value of a virtual IP address of a corresponding entry in the mapping table and then transmitted into a terminal.

Specifically, to fetch a virtual IP address of the IPv4 terminal in the same network, the IPv6 terminal 1000 first queries a domain name (e.g., www.etri.re.kr) from an IPv6 DNS server 1100 in the same network in operation S1401. The IPv6 DNS server 1100 receiving the corresponding query recognizes that there is no corresponding domain name in its cache, and transmits a virtual IP address of the IPv4 DNS server and a MAC address of the protocol conversion apparatus into a protocol conversion unit in the same network in operation S1402.

At this point, the target address of the corresponding packet is a virtual IP address of the IPv4 DNS server, and the target MAC address is set as a MAC address of the protocol conversion apparatus. The target IP address is a virtual address of the IPv4 DNS server registered in the IPv6 DNS server in advance, and the target MAC address is an address obtained by methods of FIG. 5.

The protocol conversion unit searches the transmitted virtual IP address and MAC address in the mapping table mapping the actual IP addresses of the IPv5/IPv6 and the virtual IP addresses to determine whether there is a corresponding address or not in operation S1403. In a searching result, when the received virtual IP packet corresponds to one item of the registered virtual IP address in the mapping table, the protocol conversion unit performs a protocol conversion in operation S1405, and transmits the DNS query message into the IPv4 DNS server in the same network in operations S1406 and 1407.

The IPv4 DNS server receiving the DNS query searches the corresponding query in operation S1408, and transmits a packet containing the corresponding IP address value into the protocol conversion apparatus in operation S1409. The IPv4 stack of the protocol conversion unit receives the packet to recognize that the corresponding packet is a DNS reply packet, and then transmits the packet into the DNS ALG 1250 in operation S1410. The DNS ALG 1250 recognizes that the IPv4 format address value in the payload corresponds to an actual IP address item in the mapping table that the DNS ALG 1250 itself manages, and then replaces with an IPv6 format virtual IP address of a corresponding entry in operation S1411.

In a next procedure, as illustrated in FIG. 5, the IPv6 format virtual IP address is converted into an IPv6 packet in operations S1412, 1413, 1414, and 1415, and finally an IP address of a corresponding IPv4 terminal is transmitted into the IPv6 terminal as an IPv6 format virtual IP address in operation S1416.

Following procedures are identical to that of FIGS. 5 and 6.

Procedures opposite to the above, i.e., procedures of when the IPv4 terminal fetches a virtual IP address of the IPv6 terminal, are performed identical to procedures in reverse order.

Specifically, when a DNS query is transmitted into the IPv4 DNS server in the same network, the IPv4 DNS server receiving the query recognizes that there is no corresponding domain name in its cache, and transmits a virtual IP address of the IPv4 DNS server, and a MAC address of a protocol conversion unit into a protocol conversion unit. At this point, the virtual IP address of the IPv4 DNS server is a destination address of the corresponding packet, and the MAC address of the protocol conversion unit is set as a destination MAC address. The destination IP address is a virtual address of the IPv6 DNS server registered in the IPv4 DNS server in advance, and the destination MAC address is an address obtained by a method identical to that of FIG. 5.

The protocol conversion unit searches the transmitted virtual LP address and MAC address in the mapping table mapping the actual IP addresses of the IPv5/IPv6 and the virtual IP addresses to determine whether there is a corresponding address or not. In a searching result, when the received virtual IP packet corresponds to one item of the registered virtual IP address in the mapping table, the protocol conversion unit performs a protocol conversion, and transmits the DNS query message into the IPv6 DNS server in the same network.

The IPv6 DNS server receiving the DNS query searches the corresponding query, and transmits a packet containing the corresponding IP address value into the protocol conversion apparatus. The protocol conversion unit receives the packet, recognizes that the corresponding packet is a DNS reply packet, and then transmits the packet into the DNS ALG. The DNS ALG recognizes that the IPv6 format address value in the payload corresponds to an actual IP address item in the mapping table that the DNS ALG itself manages, and then replaces with an IPv4 format virtual IP address of a corresponding entry. The DNS ALG converts the virtual IP address into an IPv4 packet, and transmits an IPv4 format virtual IP address for an IP address of the corresponding IPv6 terminal into the IPv4 terminal.

As described above, IPv4/IPv6 terminals in one physical subnet like a home network domain can utilize a protocol conversion method like a conventional SIIT through a mapping table of an actual IP address and a virtual IP address managed in a protocol conversion unit, and also can transparently communicate to each other in an IP protocol version. Moreover, terminals in one network can communicate with terminals in another network by using a conventional protocol or protocol conversion method without modification.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method of generating a mapping table of a protocol conversion apparatus, the method comprising mapping actual IP (internet protocol) addresses of IPv4/IPv6 and virtual IP addresses corresponding to the actual IP addresses to support a protocol conversion between IPv4/IPv6 terminals or application programs in one physical network environment mixed with the IPv4/IPv6 terminals or the application programs.

2. The method of claim 1, wherein the mapping comprises:
allocating an ARP (address resolution protocol) table and a neighbor table to the IPv4 terminal and the IPv6 terminal, respectively;
mapping a virtual IPv6 address into an actual IP address of an IPv4 terminal existing in the ARP table, and
mapping a virtual IPv4 address into an actual IP address of an IPv6 terminal existing in the neighbor table.

3. The method of claim 2, wherein the IPv4 terminal utilizes an actual IP address in an IPv4 format address and a virtual IP address in an IPv6 format address.

4. The method of claim 3, wherein the IPv6 terminal utilizes an actual IP address in an IPv6 format address and a virtual IP address in an IPv4 format address.

5. A protocol conversion apparatus supporting a protocol conversion between IPv4/IPv6 terminals or application programs by using a mapping table, the protocol conversion apparatus transmitting and receiving a communication request of the IPv4 terminal or the IPv6 terminal by using an IPv4/IPv6 dual stack, and supporting a protocol conversion between the IPv4/IPv6 terminals or the application programs in one physical network environment mixed with IPv4/IPv6 by using the mapping table mapping an actual IP address and a virtual IP address of the IPv4/IPv6 terminals, respectively.

6. The protocol conversion apparatus of claim 5, wherein the protocol conversion apparatus comprises:
an IPv4 stack receiving an ARP request message for a virtual address from the IPv4 terminal,
the mapping table mapping the respective actual IP address and the virtual IP address of the IPv4/IPv6 terminals;
a packet conversion unit converting packets between the IPv4/IPv6 terminals by applying a SIIT (a simple IP and ICMP transition) algorithm based on information of the mapping table; and
an IPv6 stack receiving an NDP (neighbor discovery protocol) request message from the IPv6 the terminal.

7. The protocol conversion apparatus of claim 6, further comprising respective ALGs (application layer gateways) supporting a protocol conversion in cases of IP addresses in payloads such as a DNS (domain name service), FTP (a file transfer protocol), and a SIP (session initiative protocol).

8. The protocol conversion apparatus of claim 7, wherein the respective ALGs modify an IP address information in the payload as a value of an actual IP address corresponding to a virtual IP address in the mapping table when the virtual IP address in the mapping table corresponds to a target IP address in the payload, and then transmit the modified IP address information into terminals.

9. The protocol conversion apparatus of claim 6, wherein the mapping table allocates an ARP table and a neighboring table to the IPv4 terminal and the IPv6 terminal, respectively, maps a virtual IPv6 address into an actual IP address of the IPv4 terminal in the ARP table, and maps a virtual IPv4 address into an actual IP address of the IPv6 terminal in the neighboring table.

10. The protocol conversion apparatus of claim 9, wherein, during the mapping of the address, the actual IP address has an IPv4 format address and the virtual IP address is an IPv6 format address in the IPv4 terminal.

11. The protocol conversion apparatus of claim 10, wherein, during the mapping of the address, the actual IP address has an IPv6 format address and the virtual IP address is an IPv4 format address in the IPv6 terminal.

12. A method of supporting a protocol conversion between IPv4/IPv6 terminals by a mapping table, the method comprising:
receiving and responding for a message for a communication request of the IPv4/IPv6 terminals by using an IPv4/IPv6 dual stack in one physical network environment mixed with IPv4/IPv6; and
supporting the protocol conversion between the IPv4/IPv6 terminals by using the mapping table mapping an actual IP address and a virtual IP address of the IPv4 and IPv6, respectively, to perform communication between the IPv4/IPv6 terminals.

13. The method of claim 12, wherein the communication request of the IPv4 terminal comprises the steps of
(a) transmitting an ARP reply message in response to a transmitted ARP request message instead of a terminal for communication when an IPv4 stack receives the ARP request message transmitted from the IPv4 terminal into the terminal for communication;
(b) transmitting an IP address and a MAC (media access control) address of the terminal for communication from the IPv4 terminal into the IPv4 stack by using an IPv4 packet;
(c) searching the transmitted IP address and the MAC address in an IPv4 mapping table including a mapped actual IP address and virtual IP address of IPv4/IPv6 to look up a corresponding IP address; and
(d) transmitting the converted packet into the terminal for communication by performing a protocol conversion when a target IP address among the transmitted IPv4 packet corresponds to one item of the virtual IP address in the IPv4 mapping table within the searching result.

14. The method of claim 12, wherein the communication request of the IPv6 terminal comprises the steps of
(e) transmitting an NDP reply message for the transmitted NDP request message instead of a terminal for communication when an IPv6 stack receives the NDP request message transmitted from the IPv6 terminal into the terminal for communication;
(f) transmitting an IP address and a MAC address of the terminal for communication into the IPv6 stack by using an IPv6 packet;
(g) searching the transmitted IP address and the MAC address in an IPv6 mapping table including a mapped actual IP address and virtual IP address of IPv4/IPv6 to look up a corresponding IP address; and
(h) transmitting the converted packet into the terminal for communication by performing a protocol conversion when a target IP address among the transmitted IPv4 packet corresponds to one item of the virtual IP address in the IPv6 mapping table within the searching result.

15. The method of any one of claims 12 to 14, wherein the mapping table maps an actual IP address and a virtual IP address in advance for management based on an ARP table for the IPv4 terminal and a neighbor table for the IPv6 terminal.

16. The method of claim 15, wherein the mapping of the actual IP address and the virtual IP address comprises mapping an IPv6 format address as the virtual IP address in the IPv4 terminal and an IPv4 format address as the virtual IP address for the IPv6 terminal.

17. The method of claim 12, further comprising, in cases of IP addresses in a payload including one of a DNS, a FTP, and a SIP of a terminal that the IPv4 or IPv6 terminal wants to communicate, modifying an IP address information in the payload as a value of an virtual IP address corresponding to the actual IP address through an ALG according to respective applications when an IP address in the payload corresponds to an actual IP address in the mapping table.

18. The method of claim 17, wherein, when the IPv6 terminal requests communication with the IPv4 terminal, the requesting of the communication comprising the steps of:
(i) transmitting a virtual IP address of an IPv4 DNS server and a MAC address of a protocol conversion apparatus through an IPv6 packet by transmitting a DNS query into an IPv6 DNS server and confirming that there is no corresponding domain name in a cache of an IPv6 DNS server receiving the DNS query;
(j) searching an identical IP address in an IPv6 mapping table including the mapped actual IP address and the virtual IP address of the IPv4/IPv6 terminals by receiving the transmitted virtual IP address and the MAC address from the IPv6 stack;
(k) transmitting the DNS query message into the IPv4 DNS server by performing a protocol conversion in a packet conversion unit when the received virtual IP address corresponds to one item of the virtual address registered in the IPv6 mapping table within the searching result;
(l) transmitting an IPv4 packet containing a corresponding IP address value into the IPv4 stack by searching about corresponding query in the IPv4 DNS server receiving the DNS query, acknowledging that a corresponding packet is a DNS reply packet by receiving the IPv4 packet from the IPv4 stack, and then transmitting the packet into a DNS ALG; and
(m) replacing an IPv4 format address value with an IPv6 format virtual IP address corresponding to an actual IP address after acknowledging that the IPv4 format address value in the payload corresponds to an actual IP address item in the IPv4 mapping table that the DNS ALG manages within the DNS ALG, and then transmitting an IPv6 format virtual IP address for an IP address of the corresponding IPv4 terminal into the IPv6 terminal by converting the virtual IP address into an IPv6 packet in the packet conversion unit.

19. The method of claim 17, wherein, when the IPv4 terminal requests communication with the IPv6 terminal, the requesting of the communication comprising the steps of:
(n) transmitting a virtual IP address of an IPv6 DNS server and a MAC address of a protocol conversion apparatus through an IPv4 packet using an IPv6 packet by transmitting a DNS query to an IPv4 DNS, and confirming that there is no corresponding domain name in a cache of an IPv4 DNS server receiving the DNS query;
(o) searching an identical IP address in an IPv4 mapping table mapping the actual IP address and virtual IP address of the IPv4/IPv6 terminals by receiving the transmitted virtual IP address and the MAC address in the IPv4 stack;
(p) transmitting the DNS query message into the IPv6 DNS server by performing a protocol conversion in a packet conversion unit when the received virtual IP address corresponds to one item of the virtual IP address registered in the IPv4 mapping table within the searching result;
(q) transmitting the IPv6 packet containing a corresponding IP address value into the IPv6 stack by searching about corresponding query in the IPv6 DNS server receiving the DNS query, acknowledging that a corresponding packet is an DNS reply packet by receiving the IPv6 packet in the IPv6 stack, and then transmitting the packet into a DNS ALG; and
(r) replacing the IPv6 format address value with an IPv4 format virtual IP address corresponding to the actual IP address after acknowledging that an IPv6 format address value in the payload corresponds to an actual IP address item in the IPv6 mapping table that the DNS ALG manages within the DNS ALG, and then transmitting an IPv4 format virtual IP address for an IP address of the corresponding IPv6 terminal into the IPv4 terminal by converting the virtual IP address into an IPv4 packet in the packet conversion unit.
